(19) United States
(12) Patent Application Publication
(10) Pub. No.: US 2005/0175763 A1
(43) Pub. Date: Aug. 11, 2005

(54) Functional foods containing a phospholipid-containing stable matrix

(75) Inventors: Martin Purpura, Bonn (DE); Dirk Cremer, Zolling (DE); Ralf Jager, Freising (DE); Michaela Thalhammer, Freising (DE)

Correspondence Address: FITCH EVEN TABIN AND FLANNERY, 120 SOUTH LA SALLE STREET, SUITE 1600, CHICAGO, IL, 60603-3406, US

(73) Assignee: Degussa Bloactive GmbH

(21) Appl. No.: 10/511,885

(22) PCT Filed: Apr. 17, 2003
(86) PCT No.: PCT/EP03/04032

(30) Foreign Application Priority Data
Apr. 19, 2002 (DE) 102 17 557.8

(51) Int. Cl. A23D 7/00

(52) U.S. Cl. 426/607

(57) ABSTRACT

The claimed functional foods and specialized foods each contain a physiologically compatible phospholipid-containing stable matrix consisting of a supporting material and a bioactive component, the phospholipid component being in particular phosphatidyl serine, phosphatidyl choline and similar compounds, lyso variants and/or derivatives thereof. Liquid, solid and semiliquid forms of administration are preferred as the functional foods; food for tube feeding is regarded as preferred among the specialized foods. The matrix used for this should preferably have liquid contents and in particular have a diameter between 0.1 μm and 5.0 mm. It is also preferred when the matrix develops a delayed release after its ingestion with the respective foods which should preferably take place in the gastro-intestinal tract.

The present invention concerns functional foods and specialized foods containing a physiologically compatible stable matrix.

Functional foods are foods which are ascribed a health-giving, performance-enhancing or disease-preventing benefit which goes beyond the nutritional physiological effect of comparable “normal” foods. These foods are modified compared to normal foods in order to obtain the appropriate benefit and this benefit is also clearly made recognizable to the consumer.

In addition to functional food, the terms nutraceuticals, designer foods, healthy foods, pharma foods among others are usually used internationally synonymously for functional foods.

About 1.5% of the total food market can be classified as the functional food market. Growth rates of over 10% in recent years show the dynamics of this special market.

Yogurt at about 19% currently has the highest market share of the functional foods. Functional fruit juice drinks have reached a share of about 16% in recent years. Cereal products are also in the double-digit region at just under 14%. Cream cheese has a market share of 7%, fruit juice has a market share of 6%. The market share of sport drinks at 5% is also increasing strongly. The butter/margarine group of products constitutes about 4% of the functional food market.

Hence the world market is dominated by milk products and alcohol-free drinks.

Functional foods are intended to influence a number of different bodily functions of which the metabolism of macronutrients, defence against reactive oxidants, the cardiovascular system and the physiology of the gastro-intestinal tract are of particular interest.

In industrial countries an imbalance between the requirements for micronutrients such as carbohydrates, proteins and fat and their supply is usually associated with several chronic diseases such as being overweight, non-insulin-dependent diabetes mellitus and cardiovascular diseases. Potential uses of functional foods are to support the maintenance of an appropriate body weight, to facilitate the regulation of the blood sugar level and to contribute to the regulation of blood fat concentrations.

The human organism has a number of protective mechanisms to defend against damaging oxidative substances. When there is a disorder in a balanced mechanism, the resulting oxidative damage may be causally involved in the development or progression of certain diseases. These diseases include among others cancer, cardio-vascular diseases and neurodegenerative diseases.

Diseases of the cardiovascular system are the most frequent cause of death in most industrial countries. Disorders of lipoprotein metabolism and an increased tendency for high blood pressure are involved among others in the pathogenesis.

Disorders of the normal functions of the gastro-intestinal tract can lead to diseases such as gastro-intestinal infections, digestive complaints, inflammatory intestinal diseases and intestinal cancer. The extent to which and the form in which food ingredients influence the intake and utilization of food is at present the subject of a great deal of research.

At present there are various approaches to implement the principle of “functional foods”:

Probiotics are microorganisms, usually lactic acid bacteria, which when consumed regularly, are claimed to interact with and influence the properties of the endogenous microflora in the gastro-intestinal tract. Prebiotics are defined as non-digestible food components which selectively promote the growth and/or activity of certain bacteria in the intestine. These are usually oligosaccharides such as fructo-oligosaccharides and galacto-oligosaccharides.

Antioxidants prevent the formation or reactive oxidants which damage DNA, proteins, lipids or other biomolecules. They include the vitamins E and C, carotinoids and flavonoids.

Among the group of >30,000 known secondary plant substances, 5 to 10,000 occur in human foods. They have been ascribed various preventive and beneficial health effects. Anticancerogenic and antioxidative effects are the most commonly mentioned effects.

Fat replacements and fat substitutes are used to lower the total energy. For years the diet in industrial countries has been critized among others as being too fatty and having an inadequate proportion of unsaturated fatty acids. Hence the strategy followed in functional foods is, on the one hand, to lower the proportion of fat in the total energy supply and, on the other hand, to influence the type of ingested fatty acids. Fat substitutes are products that are manufactured from fatty acids but have a reduced energy balance. Fat substitutes are protein-based or carbohydrate-based products.

Omega-3 fatty acids from fish oils are claimed among others to have an anti-inflammatory effect in various autoimmune diseases and to reduce the risk for cardiovascular disease and stroke. In Japan these products are marketed for performance enhancement. In addition to bread, eggs and breakfast cereals, wellness drinks containing omega-3 fatty acids are also on the market.

Finally functional foods also include bioactive peptides. These milk proteins are for example caseins which are regarded to be precursors of bioactive peptides, lactalbumin which has been claimed to have an anticancerogenic effect and lactoferrin which is claimed to have a microbial, antioxidative and anticancerogenic effect. In addition the bioactive peptides have been claimed to have hormone-like and regulating properties.

Specialized foods are also referred to as special nutrition or clinical nutrition and are mainly administered in the medical field for tube feeding.

From the known prior art the object of the present invention is to provide functional foods and specialized foods which in addition to the known ingredients that are already commonly used in this function, contain further components in order to exploit in this manner an additional spectrum of action of these special foods.

This object is achieved by functional foods and specialized foods (both denoted foods or special foods in the following) which contain a physiologically compatible phospholipid-containing stable matrix which is composed of a supporting material and a bioactive component.

The phospholipid class of substances are so-called complex lipids having amphiphilic i.e. simultaneous lipophilic and hydrophilic properties which, among others, enables them to form lipid bilayers in aqueous media.

Phospholipids (also called phosphatides) are in a chemical sense phosphodiesters in which the phosphoric acid is esterified, on the one hand, with a sphingosine or glyceride residue and, on the other hand, with choline, ethanolamine, serine, inositol or glycerol. Phosphatidyl choline is also known as lecithin and is also the eponym for a large group of special phospholipids, the lecithins. Phosphatidyl serine and phosphatidyl ethanolamine are also referred to as cephalins.

The lyso derivatives which also belong to this group are formed by hydrolytic cleavage by specific phospholipases.

Phospholipids are typically insoluble in acetone which is why they are also referred to as acetone-insoluble phosphatides or acetone-insoluble substances. Lecithins are mixtures or fractions of phosphatides which are isolated by physical processes from animal or vegetable foods. Lecithins contain at least 60% substances that are insoluble in acetone. Due to this property lecithin-containing products can be tested for their actual phosphatide or phospholipid content with the aid of the so-called acetone solubility test.

In addition to the head group (i.e. serine, choline, inositol etc.), these compounds preferably contain one residue at each position sn-1 or sn-2 which is derived from a C₂-C₃₀ carboxylic acid, in particular a C₁₂-C₂₈ carboxylic acid bound to the hydroxyl groups of the glycerol. The acidic residues can be linear or branched, saturated or monounsaturated or polyunsaturated. Particularly preferred residues are residues that are formed by the binding of acetic acid, butyric acid, caproic acid, caprylic acid, capric acid, lauric acid, myristic acid, arachidic acid, behenic acid, lignoceric acid, β-linolenic acid, eicosapentaenoic acid, erucic acid, nervonic acid, α- or β-eleosteric acid or parinaric acid. Residues are particularly preferred which are formed by the binding of palmitic acid, stearic acid, oleic acid, linoleic acid, α-linolenic acid, arachidonic acid or docosahexaenoic acid. The acidic residues bound to the OH groups of the glycerol that are still available can in this case be the same or different.

Phospholipid-containing capsules are well-known from the prior art and contain phospholipids usually as a coating substance. If phospholipids are used in the filling i.e. in the core of the capsule they usually act there in small amounts as a formulation adjuvant usually having solubilizing properties.

Soft gelatin capsules containing lecithin as a bioactive ingredient are commercially available as KAL®-Lecithin and contain 1200 mg soya lecithin. However, in order to accommodate this amount of lecithin in a capsule, capsule sizes have to be selected which come close to the centimetre limit and thus give rise to a limited compliance. Furthermore soft capsules only have a limited stability due to hydrolytic processes.

DE-PS 199 17 249 also describes soft gelatin capsules. In this connection phosphatidyl serine (products) are also claimed to be stabilized by embedding them in a hard fat in aqueous systems which also makes them suitable as a drink additive. In this case a soft capsule with hard contents is obtained as a product.

Surprisingly the claimed special foods not only have additional beneficial health properties according to the object, but moreover make it possible to make new functional foods and specialized foods which are characterized by the special stable matrix. Thus it is for example possible to use the matrix to incorporate phospholipids into foods to which these exogenous additives could previously not be added due to formulation problems and also due to the sensitivity of the phospholipids to hydrolysis and oxidation. In particular it is now possible to simply and stably enrich fermented milk products and drinks in general, cereals in the form of flakes and extruded products with phospholipids. Thus most of these advantages were not predictable.

According to the present invention functional foods are preferred which are liquid, solid or semiliquid forms of administration. In principle all foods are suitable for this such as meat and meat products (boiled sausages, pies, sausage spread); processed fruit, processed vegetables (e.g. in tinned foods), potato products such as mashed potatoes, delicatessen salads, puddings, sweet deserts, oil seeds and pastes and sweets (marzipan) produced therefrom, ice cream, spices and other seasoning additives, honeys, teas, tea-like products, extracts and preparations thereof, bread and biscuits, fancy cakes and pastries, pastas. In addition jams, margarine and mixed fats, cheese, milk, milk products (i.e. sour milk, yogurt, kefir, buttermilk, cream, coffee cream, condensed milk, milk powder, yogurt powder, sweet whey, whey powder, milk protein, milk sugar) are among others suitable and in general dietary foods, baby foods and egg products. According to the present invention teas, coffees, milk and mineral drinks, soft, power and energy drinks, vegetable, fruit, bark juices and nectars, liquid spices, elixirs and tonics, soft drinks and beers are particularly suitable. Among the solid forms of administration, cereal products, extracts of spices, plants, fruits and bark, and bars, pastas, sweets, slices and soft products such as gummy and foam products are particularly suitable.

Fermented milk products such as butter, yogurt, cottage cheese, kumis, kefir, cheese and also ready-to-use sauces, margarine, bread spreads and cremes are also preferred examples of semiliquid forms of administration.

In the case of the claimed functional foods and specialized foods which are preferably a tube feed, particular emphasis is given to the aspect of special foods which within the scope of the present invention are especially characterized in that the matrix contains ≧5% by weight and particularly preferably ≧15% by weight based on the starting material of acetone-insoluble phospholipid components as the bioactive component.

According to the present invention the term “matrix” is defined as the entirety of supporting material and bioactive component. In this connection the supporting material can be homogeneously or heterogeneously mixed with the bioactive component, the supporting material can at least partially enclose the bioactive component as a coat or the bioactive component can be applied to the supporting material. Also mixed forms of the variants are possible. However, the present invention claims in particular matrix forms which are pellets, granulates or capsules, microcapsules being preferred which are preferably composed of a coat and a bioactive core.

In connection with the present invention the term “bioactive” is understood as the effect of phospholipids during or after their release from the capsule to develop a biological effect in the living organism which usually occurs with corresponding preparations in the human and veterinary field in the area of absorption, on the transport path or at the target site.

According to the present invention a matrix is preferred which contains between 5 and 90% by weight, in particular between 20 and 80% by weight and most preferably between 40 and 70% by weight in each case based on the starting material of acetone-insoluble phospholipid components, where phosphatidyl serine, choline, ethanolamine, inositol, glycerol, lyso compounds thereof and/or derivatives thereof are regarded as preferred acetone-insoluble components. Furthermore, sphingophospholipids have turned out to be particularly suitable of which sphingomyelin and derivatives thereof are preferred.

In this connection the origin of the bioactive component is not limited at all; but it can be of microbial and also vegetable (including algae) and animal origin or can be produced or modified synthetically.

(Un)-modified carbohydrates and proteins, hydrophobic materials such as waxes, triglycerides, lipids and polymers or mineral components such as silicates and mixtures thereof have proven to be particularly suitable as supporting materials of the stable matrix. The lipids can be hydrogenated or have a special composition; the polymers can be pharmaceutical polymers and/or polymers suitable for foods. In this connection cereal products such as of maize, wheat, oats, rices etc. deserve particular mention which represent typical supporting materials as flakes or extrudates.

In order to take the respective matrix forms and applications into account, the invention envisages that in particular starch (derivatives), mono- and disaccharides and their sugar alcohols, glucose syrup, dextrins and hydrocolloids such as alginates, pectins, chitosan and cellulose (derivatives) are used as representatives of the carbohydrates. Particularly suitable representatives of proteins are plant, animal and microbial proteins such as zein, gluten, gelatin, casein, whey proteins or mixtures thereof and also single-cell proteins and texturized proteins such as spun or extruded (soya) protein isolate.

Each of the special representatives can of course be supplemented by other suitable coating materials if necessary of which maltodextrins, sucrose, mono- and disaccharides, modified starches (e.g. esters and ethers), gum acacia, xanthan gum, gum arabic, carrageenan, furcelleran, agar, alginates, tragacanth and carboxymethyl cellulose are particularly recommended as carbohydrates.

Hydrogenated vegetable oils can also be used as hydrophobic materials as an addition to the preferred representatives, and also natural oils such as palm oil, cotton seed oil, soybean oil, maize oil, palm kernel oil, babassu oil, sunflower oil and safflower oil, which can also be mixed with bee wax, petroleum-based paraffin wax, rice bran wax, castor wax and microcrystalline wax, candellila wax, carnauba wax and shellac.

Other recommended representatives of the lipids are tristearins, stearic acid and fats where of course the phospholipids themselves can also be selected according to the prior art as a coat or a component thereof.

The range which can be covered by the supporting material is just as wide as the range for the proportion of bioactive component. Proportions of ≦95% by weight and in particular proportions between 30 and 80% by weight based on the total matrix weight have proven to be effective. The proportion of supporting material in the matrix is preferably ≧5% by weight, in particular ≧10% by weight, more preferably ≧20% by weight, even more preferably ≧40% by weight and most preferably ≧50% by weight and up to 95% by weight, in particular up to 90% by weight, more preferably up to 70% by weight and even more preferably up to 60% by weight. In this manner the amounts of ingredient can be exactly adapted to the type of supporting material and to the respective application.

According to the invention particularly suitable supporting materials are substances which enable the formation of a complete encapsulation as well as substances which provide a matrix of high stability and low shear stress.

For the claimed special foods (functional foods, specialized foods) the total matrix should have a preferred diameter between 0.1 μm and 5.0 mm and in particular between 0.5 and 2.5 mm which applies in particular to the preferred capsule form.

Although a matrix which only contains phospholipids as a bioactive component is in the foreground of the present invention, the matrix can of course also contain other bioactive substances in addition to the main components or mixtures thereof such as amino acids, vitamins, lipids, polyphenols, carbohydrates, trace elements, mineral substances and suitable derivatives thereof. Essential amino acids are especially suitable and also for example creatine or other special amino acids such as theanine and derivatives thereof; fat-soluble vitamins such as those of the vitamin E family, the tocotrienols, phytostearins and other accompanying fatty substances can be used as representatives of the vitamins, as well as representatives of the vitamin D series or vitamin C which are different from the phospholipids. Typical fish oil lipids have also proven to be suitable such as docosahexaenoic and eicosahexaenoic acid or in general omega-3 fatty acids in a triglyceride form and conjugated linolenic acid. These other bioactive substances can be added to the supporting material, the bioactive component or to both.

One of the advantages of the present invention has proven to be the fact that the matrix is not limited to a special form, but can have a spherical, round or irregular shape. However, spherical or lens-shaped embodiments have proven to be particularly suitable, but of course other shape variants such as cylinders, rods, cushions, flakes and such like can be used depending on the application and are always of course composed of the supporting material and the bioactive component.

A food is preferred which contains a microcapsule having a preferred diameter between 0.5 and 500 μm as the matrix.

Finally the invention also provides a food variant which contains a matrix with contents having a liquid consistency which usually necessitates a more or less rigid coat.

For special applications it may be advantageous when the capsules present in the claimed food develop a delayed release which should take place in particular in the gastrointestinal tract (GI-tract). However, for this purpose the matrix itself and its components (the supporting material and the bioactive component) do not have to be completely resistant to gastric juice or be able to resist the chemical and/or enzymatic effects of the GI-tract.

A preferred application for the claimed matrix is to prevent an elevated serum cholesterol level and as a prophylaxis against (a)typical diabetes symptoms; and also to strengthen mental fitness, exercise tolerance and fitness are also encompassed by the present invention.

The matrix forms contained in the claimed functional foods and specialized foods are particularly advantageous forms of administration for the said special food forms due to their special features such as diameter, coat or capsule core since they can be produced in many different forms and thus cannot only be adapted to the needs of the consumer but also impart additional positive properties to the conventional special foods which relate not only to the physiological effectiveness of the entire food and the added matrix but also to the possibility of for example completely or partially pigmenting, aromatizing and/or specially shaping the matrix. In this manner it is now possible to stably incorporate phospholipids over a long period into media which were previously not accessible due for example to oxidative or hydrolytic effects or because of pH and solubility problems.

The following examples underline the advantages of the claimed special foods with the phospholipid-containing stable matrix contained therein.

### EXAMPLES

### Example 1

Microcapsule Containing 8% by Weight Phosphatidyl Serine

A 20% by weight solution of phosphatidyl serine (LeciPS° 20F from the Degussa BioActives GmbH) consisting of a mixture of triglycerides, phospholipids and glycolipids was encapsulated with a natural vegetable fat into a matrix with the aid of the known “spray technology”. The natural vegetable fat was characterized by the following features: Melting point ca 55° C., peroxide number max. 2 meq 0/kg, acid number max. 1 mg KOH/g, iodine number max. 5 gl/100 g, saponification number 185-215 mg KOH/g, more than 94% of the natural acids (ca. 33% palmitic acid, ca. 60% stearic acid) were saturated.

The spherical matrix obtained in this manner in the form of microcapsules had an average total diameter of 100 to 250 μm and the following composition: 8% by weight phosphatidyl serine, 55% by weight vegetable fat and 37% by weight of a mixture of triglycerides, glycolipids and other phospholipids.

These microcapsules were incorporated into an orange juice drink (pH 3.5). The stability of the phosphatidyl serine was 90% (starting at 100%) for 7 weeks under continuous storage conditions of 4° C.

### Example 2

Microcapsule Containing 14% by Weight Phosphatidyl Choline

A 35% by weight solution of phosphatidyl choline (Epikuron® 135F from the Degussa BioActives GmbH) consisting of a mixture of triglycerides, phospholipids and glycolipids was encapsulated with a natural vegetable fat into a matrix with the aid of the known “spray technology”. The natural vegetable fat was characterized by the following features:

Melting point ca 55° C., peroxide number max. 2 meq 0/kg, acid number max. 1 mg KOH/g, iodine number max. 5 g/100 g, saponification number 185-215 mg KOH/g, more than 94% of the natural acids (ca. 33% palmitic acid, ca. 60% stearic acid) were saturated.

The spherical matrix obtained in this manner in the form of microcapsules had an average total diameter of 100 to 250 μm and the following composition: 14% by weight phosphatidyl choline, 46% by weight vegetable fat and 40% by weight of a mixture of triglycerides, glycolipids and other phospholipids.

These microcapsules were stirred into a commercial fruit yogurt and remained substantially resistant to hydrolysis and oxidation at a value of 93% phosphatidyl choline (starting at 100%) after 7 weeks.

### Example 3

Microcapsule Containing 50% by Weight Phosphatidyl Serine

A 90% by weight phosphatidyl serine powder in the form of a lecithin concentrated from soybeans (LeciPS® 90PN from the Degussa BioActives GmbH) was encapsulated with a natural vegetable fat into a matrix with the aid of the known “fluid-bed technology”. The natural vegetable fat was characterized by the following features:

Melting point ca 55° C., peroxide number max. 2 meq 0/kg, acid number max. 1 mg KOH/g, iodine number max. 5 gl/100 g, saponification number 185-215 mg KOH/g, more than 94% of the natural acids (ca. 33% palmitic acid, ca. 60% stearic acid) were saturated.

The spherical matrix obtained in this manner in the form of microcapsules had an average total diameter of 100 to 250 μm and the following composition: 5% by weight phosphatidyl serine, 45% by weight vegetable fat and 5% by weight phospholipids.

The microcapsules obtained in this manner were incorporated into a chocolate bar. The phosphatidyl serine components of the microcapsules were substantially resistant to hydrolysis and oxidation with a value of 91% (starting at 100%) after 7 weeks.

1. Functional food containing a physiologically compatible phospholipid-containing stable matrix consisting of a supporting material in the form of (un)modified carbohydrates and proteins, hydrophobic materials such as waxes, triglycerides, lipids and polymers or mineral components such as silicates and mixtures thereof, and containing ≧5% by weight based on a starting material of acetone-insoluble phospholipid components as a bioactive component.

2. Functional food as claimed in claim 1, characterized in that it is a liquid, solid or semiliquid form of administration.

3. Functional food as claimed in claim 2, characterized in that it is a tea, coffee, milk or mineral drink, soft, power or energy drink, a vegetable, fruit or bark juice or nectar, liquid spice, elixir or tonic, soft drink or beer.

4. Functional food as claimed in claim 2, characterized in that it is a cereal product, a spice, an extract of plants, fruits or bark, a bar, pasta, sweet, slice or a soft product such as gummy and foam product.

5. Functional food as claimed in claim 2, characterized in that it is a fermented milk product such as butter, yogurt, cottage cheese, kumis, kefir, ready-to-use sauces, margarine, bread spread or creme.

6. Specialized food containing a physiologically compatible phospholipid-containing stable matrix consisting of a supporting material in the form of (un)modified carbohydrates and proteins, hydrophobic materials such as waxes, triglycerides, lipids and polymers or mineral components such as silicates and mixtures thereof, and containing >5% by weight based on a starting material of acetone-insoluble phospholipid components as a bioactive component.

7. Specialized food as claimed in claim 6, characterized in that it is a food for tube feeding.

8. Food as claimed in claim 1, with the matrix being pellets, granulates or capsules, especially microcapsules, preferably composed of a coat and a bioactive core.

9. Food as claimed claim 6, wherein the matrix contains ≧15% by weight in each case based on the starting material of acetone-insoluble phospholipid components as the bioactive component.

10. Food as claimed in claim 9, wherein the matrix contains between 5 and 90% by weight, in particular between 20 and 80% by weight and particularly preferably between 40 and 70% by weight in each case based on the starting material of acetone-insoluble phospholipid components.

11. Food as claimed in claim 1, characterized in that the matrix contains phosphatidyl serine, phosphatidyl choline, phosphatidyl ethanolamine, phosphatidyl inositol, phosphatidyl glycerol, lyso variants thereof and/or derivatives thereof as acetone-insoluble components, and/or sphingophospholipids in particular sphingomyelin.

12. (canceled)

13. Food as claimed in claim 1, wherein the carbohydrates are starch (derivatives), mono- and disaccharides and their sugar alcohols, glucose syrup, dextrins and hydrocolloids such as alginates, pectins, chitosan and cellulose (derivatives).

14. Food as claimed in claim 13, wherein the proteins are plant, animal or microbial proteins such as zein, gluten, gelatin, casein or whey proteins, single-cell proteins, proteins from algae or texturized proteins or mixtures thereof.

15. Food as claimed in claim 14, wherein the proportion of supporting material is ≦95% by weight and in particular between 30 and 80% by weight based on the total weight of the matrix.

16. Food as claimed in claim 15, wherein the total matrix has a diameter between 1.0 μn and 5.0 mm and in particular 0.5 to 2.5 mm especially in a capsule form.

17. Food as claimed in claim 16, wherein the matrix contains additional bioactive substances such as amino acids, vitamins, polyphenols, carbohydrates, lipids, trace elements, mineral substances and suitable derivatives thereof.

18. Food as claimed in claim 17, wherein the matrix is spherical or has a lens shape.

19. Food as claimed in claim 18, containing the matrix as microcapsules having a preferred diameter between 0.5 and 500 μm.

20. Food as claimed in claim 20, wherein the matrix has liquid contents.

21. Food as claimed in claim 19, the matrix develops a delayed release especially in the gastrointestinal tract (GI tract)

22. (canceled)

23. A pharmaceutical preparation for preventing elevated serum cholesterol levels and diabetes symptoms, strengthening mental fitness, exercising tolerance and fitness, comprising the food claimed in claim 1.
